(19) United States
(12) Patent Application Publication
(10) Pub. No.: US 2026/0133368 A1
(43) Pub. Date: May 14, 2026

(54) FIBER BEAM SHAPER

(71) Applicant: IPG PHOTONICS CORPORATION, Marlborough, MA (US)

(72) Inventors: Leonid KLEBANOV, Hopkinton, MA (US); Luis Alberto CEPEDA, Cranston, RI (US); Mikhail MELESHKEVICH, Westborough, MA (US)

(73) Assignee: IPG PHOTONICS CORPORATION, Marlborough, MA (US)

(21) Appl. No.: 19/118,123

(22) PCT Filed: Oct. 4, 2023
(86) PCT No.: PCT/US23/34421

§ 371 Date: Apr. 3, 2025

(51) Int. Cl. G02B 6/26; G02B 6/255; H01S 3/067

(52) U.S. Cl. CPC G02B 6/262; G02B 6/2551; G02B 6/2553; G02B 6/2555; H01S 3/06783; H01S 2301/203; H01S 2301/206

(57) ABSTRACT

A beam shaper includes upstream and downstream fibers fused together at a splice angle different from a zero angle and controllably increased to provide a transformation of a Gaussian intensity distribution profile at an input of the upstream fiber to an intensity distribution profile including one of flattop, inverse Gaussian and donut-shaped profiles at an output of the downstream fiber. The fibers are selected from SM, MM passive and active fibers with the downstream fiber being a multimode fiber.

### BACKGROUND OF THE DISCLOSURE

### Field of the Disclosure

The disclosure relates to beam-shaping assemblies. More particularly, the disclosure relates to an all fiber beam shaper and system for assembling the disclosed fiber beam shaper.

### Background Art Discussion

The SM output of the lasers, including fiber lasers, has a Gaussian intensity distribution profile, which is suitable for many applications such as cutting where a central high intensity region of the intensity profile is desired. However, certain applications such as welding, photolithography and processing of semiconductor wafers and others require a more uniform intensity profile. In comparison with the Gaussian profile, the flattop and ring/donut-shaped distribution provide more uniform temperature distribution across the illuminated area - this improves the technology, reduces the heat affected zone (HAZ), increases the stability of processes and efficiency of using the laser energy. The ring/donut-shaped distribution profile is often used in, among others, medicine, for example, ophthalmology, laser welding, and the material ablation of thin films.

Various beam shaping techniques are used to produce the desired intensity distributions. These techniques, as a rule, include the transformation of the laser irradiance distribution from a Gaussian profile to a uniform flattop, inverse-Gaussian or donut/ring-shaped profile. Some of these techniques utilize filters with radially varying absorption profiles, diffractive elements like holograms and refractive optics which convert a Gaussian beam to a flattop beam. These methods have their own limitations: modest efficiency, low fabrication tolerance, alignment control and wavelength sensitivity, to name a few.

Some of known attempts toward achieving, for example, a flattop beam include fiber based optical beam shaping owing to its low attenuation loss, compact design and flexibility in delivering the laser light. Square core jacketed air-clad fiber has been proposed to deliver flattop, high power beams using multimode fibers. However, the cost of this kind of specialty fiber is much higher than most standard fibers. There have been few reports on fiber beam shaping systems using all-fiber long period grating (LPG) and single mode abrupt tapered fibers. The loss and wavelength dependency of LPGs limit the applications of thus configured systems.

Other known techniques utilize beam shapers which are selected from field mapping refractive beam shapers, such as like π-Shaper, Fresnel zone plates, and axicons. As one of ordinary skill realizes, these beam shapers are expensive bulk optical components which require optical alignment.

Another well-known technique, which is used for the disclosed beam shaper, utilizes the phenomenon of generation of meridional rays in a multi-mode (MM) fiber receiving single mode (SM) light which is launched at the controlled angle. The output beam of this configuration has a well-pronounced ring-shaped intensity distribution profile. The coupling of the SM input beam into the MM fiber requires a two-lens numerical aperture (NA) converter, coated fiber tips of respective launching SM and receiving MM fibers and precise optical alignment. Additionally, it produces non-uniform specular structure which is an arrangement of small regions on the illuminated area cumulatively creating a non-uniform intensity landscape. Obviously, when the uniform intensity is desired, its nonuniformity is not highly appreciated.

In summary, the known beam shapers are typically configured with bulk elements even if a MM fiber is used to shape the transmitted beam. The bulk optic components are expensive and associated with free space beam propagation often resulting in misalignment.

It is therefore desirable to provide an all fiber beam shaper and system for assembling it so as to avoid the use of bulk optic components, component misalignment and cost inefficiency of the known beam shapers and systems utilizing them.

### BRIEF SUMMARY OF THE DISCLOSURE

The disclosed all fiber beam shaper satisfies this need. The disclosed beam shaper is based on a known structural approach in which by changing the input angle of the light launched into in a MM fiber, the shape of the beam at the output of this fiber is controllably altered. In other words, the intensity profile is a function of the incident angle.

Structurally, the inventive beam shaper is configured with at least two fibers which are spliced to one another at a splice angle. As the splice angle controllably increases, the Gaussian profile of the input SM light propagating through thus formed waveguide gradually changes to a flattop-shaped, inverse Gaussian-shaped and finally to donut-shaped intensity profile.

In accordance with one modification, the inventive beam shaper is configured with a waveguide including an input SM fiber which is angularly spliced to an input of MM fiber. When coupled into the MM fiber, the SM light characterized by a Gaussian intensity profile excites multiple skew modes forming thus an intensity profile which is different from the Gaussian one.

In accordance with a further modification of the inventive concept, the disclosed beam shaper is configured with two MM fibers which are spliced together at an angle. The input MM fiber receives SM light from a SM fiber which is butt-spliced to the upstream end of the input MM fiber. Yet this modification does not require the collinearity between the SM and input MM fibers, and can provide a light spot with the shape differing from the Gaussian one at the downstream end of the output MM fiber which depends on the splice angle between two MM fibers.

The splice angle so important for obtaining the desired intensity profile at the output of the inventive structure is selected from a range of angles. A well-pronounced donut shape is obtained with two fibers spliced at the splice angle ranging between 8° and 12°. Obviously, if the Gaussian output is preferred, the fibers have respective ends, which are to be butt-spliced together, extending coaxially and collinearly with one another. The flattop and inverse Gaussian profiles are obtained by splicing two fibers at an angle which ranges between 1° and 7°.

Fiber splicing is the process of permanently joining two fibers together. The most widely used splicing technique is known as fusion splicing. In fusion splicing, two fibers are literally welded together by an electric arc. Fusion splicing is done by an automatic machine called fusion splicer or fusion splicing machine. The fiber ends are prepared, cleaved, and placed in alignment fixtures on the fusion splicer. At the press of a button, the fiber ends are heated with electrodes, brought together, and fused. A great variety of fusion splices have something in common: these known machines splice only those fibers that are aligned with one another.

Accordingly, another aspect of the disclosure relates to a fusion splicer provided with two holders for supporting respective fibers which are further fused to one another at a splice angle. To obtain the angular splice, the holders are pivotal relative to one another within a range of angles corresponding to respective desired intensity profiles at the output of the disclosed beam shaper. The desired intensity profile is selected from the group consisting of Gaussian, flattop, inverse Gaussian and donut profiles and any transient distribution between these four standard shapes.

### BRIEF DESCRIPTION OF THE DRAWINGS

The above and other structurally and conceptually complementary features will become more apparent with reference to the accompanying figures, which are not drawn to scale. The figures provide an illustration and a further understanding of the various intertwined aspects and schematics, and constitute a part of this specification, but do not represent the limits of any particular schematic or aspect. In the drawings, each identical or nearly identical component that appears in various figures is denoted by a like numeral. In the figures:

FIG. 1 is a diagrammatic view of the inventive beam shaper in accordance with one structural modification of the inventive concept;

FIGS. 2A, 2B, 2C and 2G are respective diagrammatic illustrations of Gaussian, flattop, inverse Gaussian and donut-shaped intensity distribution profiles;

FIGS. 2D-2F illustrate respective Gaussian, flattop and inverse Gaussian beams;

FIGS. 3A-3B illustrate respective meridian and skew rays;

FIG. 3 is a diagrammatic view of the disclosed beam shaper in accordance with one modification thereof;

FIG. 4 is a diagrammatic view of the disclosed beam shaper in accordance with another modification thereof;

FIG. 5 is a photograph illustrating the light spot which is produced by the inventive beam shaper of FIG. 1;

FIG. 6 is a photograph of the light spot produced by the inventive beam shaper of FIG. 4;

FIG. 7 is a highly diagrammatic view of the inventive fiber holding assembly used in a fusion splicer; and

FIG. 8 is a diagrammatic view of high power fiber laser system utilizing the disclosed beam shaper.

### SPECIFIC DESCRIPTION

The inventive concept relates to a fiber beam shaper for controllably modifying the intensity profile of a SM Gaussian beam as it propagates through the inventive beam shaper. The latter is configured with at least two or more fibers which are fused to one another at a splice angle. Controlling the splice angle, the beam at the output of the beam shaper may have one of standard Gaussian, flattop, inverse Gaussian and donut shapes, as well as any transient shape between any two adjacent standard shapes. Associated with the known prior art complexity, alignment and cost problems are solved by utilizing a fusion splicing system operable to splice two fibers at an angle selected from a range of angles which are associated with respective intensity distribution profiles.

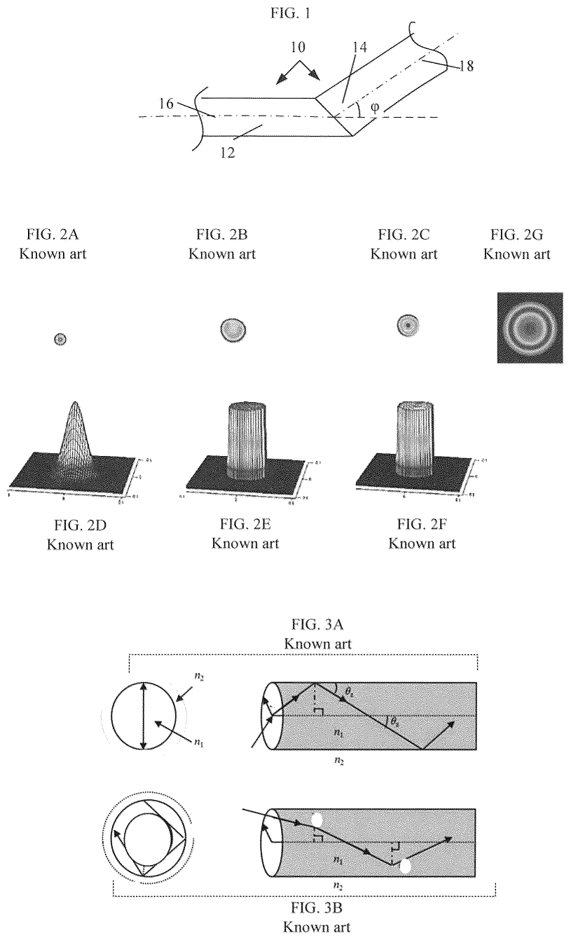

FIG. 1 illustrates the basic inventive configuration of beam shaper 10 including a SM input upstream fiber 12 and a MM fiber 14. The opposing ends of respective fibers are each cleaved at a half splice angle, for example ±5° , and further fusion-spliced at a splice angle φ, such as 10° here, wherein the splice angle is the angle between the continuation of a fiber axis 16 and axis 18 of respective fibers 12 and 14. The intensity distribution profile (or beam shape) at the output of MM fiber 14 is a function of splice angle φ.

At the splice angle within a zero to 3° range, which corresponds to a substantially coaxial and collinear relationship between axes 16 and 18 respectively, the Gaussian beam of FIG. 2D coupled into the input of SM fiber 12 gradually changes at the output of MM fiber 14. As seen in FIG. 2A, the Gaussian intensity distribution is characterized by a high intensity small central region (red spot). The beam shape at the output of MM fiber 14 begins to clearly change in response to the increase of the splice angle as it approaches 6° . It transforms to a flattop beam of FIG. 2E associated with a large (light green) central region of FIG. 2B which has a substantially uniform intensity distribution. Increasing the splice angle further to about 8-9°, the flattop beam changes to the inverse Gaussian intensity distribution of the output beam of FIG. 2F. The latter is characterized by a central region—dark green spot of FIG. 2C—which has a substantially lower level of intensity than that of the central bright red spot in FIG. 2A. Finally, as shown in FIG. 2G, the splice angle ranging from about 9 to 12° causes the transformation of the Gaussian beam to the donut-shaped beam.

Speaking of angle ranges, one of ordinary skill readily understands that each of the above discussed beam shapes is not something that is etched in stone. These shapes are rather broadly defined. Only because, for example, FIG. 2G shows some slightly heightened intensity in the central region (as opposed to a complete absence thereof), the donut shape does not have to be rebranded to an inverse Gaussian and vice versa. Accordingly, giving or taking a degree or two does not alter the inventive concept, and the best description of any given beam shape should necessarily include the words of approximation such as “substantially” or “about” or the like. Hence the angle ranges given here are not considered to be kind of “statutory” terms, but rather as a guide to better understanding of physics related to the beam shape concept. The criterion for the selection of the splice angle should take into account the fact that as the splice angle increases, so does a numerical aperture (NA) at the output of the upstream (SM fiber 12 in FIG. 1). The larger the NA, the higher the power losses. As a consequence, to minimize these losses, the NA of the downstream fiber, such as MM fiber 14, is larger than that of upstream fiber 12. Thus, the selection of the splice angle should always be viewed in light of acceptable power losses. For example, a 15° splice angle causes very high power losses while providing the output beam with an acceptable donut shape. Accordingly, one of ordinary skill would select the desired angle associated with the intensity profile to be used for the task at hand in light of the power losses at the splice between the fibers which do not exceed a predetermined reference value. Moreover while patent offices and courts see alleged uncertainty of what looks like a perfect certainty to any practitioner, the absence of strictly-defined angular ranges provides the inventive beam shaper with additional advantages. In particular, one can obtain a slightly less “perfect” beam shape which nonetheless will be highly advantages for any concrete task at hand by simply slightly increasing or decreasing the splice angle. These less than “perfect” beam shapes may be thought of as transient beam shapes between any two adjacent “perfect standard shapes” such as Gaussian and flattop, or flattop and inverse Gaussian, or inverse Gaussian and donut.

FIGS. 3A and 3B provide the illustration and explanation of the dependence between the angle incident on a waveguide and beam shape. There are two general types of rays in the fiber. One type is the meridional rays of FIG. 3A which pass through the central core axis of the fiber after each reflection from the interface between the core and surrounding cladding. The other type is known as the skew rays which never pass through the core axis but propagate in a helical path along the core, as illustrated in FIG. 3B.

With the increased angle, the proportion of skewed rays relative to the meridian rays increases which gradually modifies the intensity profile at the output of the MM fiber from the Gaussian shape to the donut shape via the flattop and inverse Gaussian shapes. The increased splice angle causes the excitation of more and more skew rays (and less and less meridian rays) providing a gradual transformation of the Gaussian beam to the flattop, inverse Gaussian and finally to the donut-shaped intensity distribution at the output of the MM fiber.

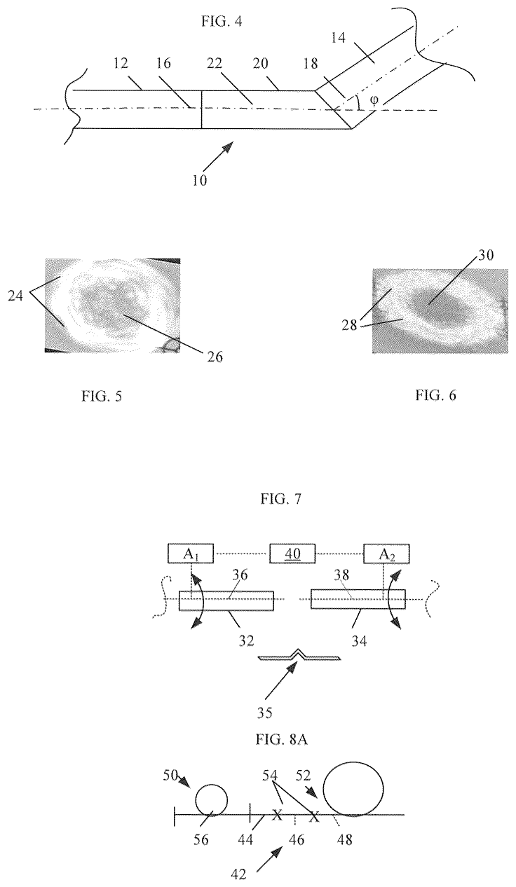

FIG. 4 illustrates another modification of inventive beam shaper 10 configured with input/upstream SM fiber 12, downstream/output MM 14 and still another MM fiber 20 which extends along an axis 22 between fibers 12 and 14 respectively. The MM fibers 20 and 22 are fused together at the splice angle φ with downstream fiber 14 having a clad diameter at least equal to that of MM fiber 20. Also, MM downstream fiber 14 is configured with an NA greater than that of MM fiber 20 due to the increased output NA of the latter. The increased NA can be obtained by using, for example, a Teflon™ fiber or doping the clad with well-known dopants which increase the NA. The upstream SM fiber 12 guiding light either directly from a SM source or coupled to the output of at least one intermediary SM fibers extends coaxially with MM fiber 20. Alternatively, SM upstream fiber 12 is fused to the input of MM fiber 20 at an angle which can be equal to or different from the splice angle φ between the MM fibers 20 and 14.

The experiments conducted with the configurations of respective FIGS. 1 and 4 demonstrated the results varying from satisfactory to very good. FIG. 5 illustrates a photograph of the donut-shaped beam at the output of MM fiber 14 of FIG. 1. The configuration of FIG. 1 is part of the schematic tested with a 30W SM erbium (Er) fiber laser (not shown) with SM fiber 12 being the laser output fiber which is fused to MM fiber 14 at 10°. The donut shape is clearly articulated with a low-intensity annular central region 26 if compared to the intensity at the periphery of the donut. Yet, even this level of intensity in region 26 may be lowered by selecting a slightly different splice angle. The donut periphery exhibits large speckles 24. In laser applications which require uniform intensity, the presence of large isolated speckles is highly undesirable since any individual speckle is characterized by intensity which is higher than that of the surrounding area. The speckles 24 each are clearly isolated from one another, large and highly contrasted with the rest of the donut periphery which indicates a relatively large high intensity gradient across the periphery. Yet those industrial applications that are not overly concerned with the high uniform intensity distribution can advantageously use the inventive beam shaper of FIGS. 1 and 5.

The intensity distribution, as shown in FIG. 6, is radically improved compared to that of FIG. 5 which is a result of the structure of FIG. 4 in which two MM fibers are angularly fused together. Not only central region 30 in FIG. 6 has a much lower intensity level than that of region 26 in FIG. 5, but also the presence of numerous small speckles 28, which tend to mix up together, provides a much more uniform intensity distribution. The output MM fiber 14 in this configuration is selected from specialty fibers with Teflon coating which increases an NA from, for example, 0.2—typical NA for regular MM fibers—to 0.5 and minimizes power losses down to 1-2%.

FIG. 7 illustrates the inventive principle of a position-adjusting system 35 which can be used in conjunction with any known or new fusion splicer. Any automatic fusion splicer has a holder assembly which is configured with two holders 32 and 34 holding respective fibers 36, 38. According to the inventive concept, holders 32, 34 are mounted on respective supports (not shown) so as to pivot about respective parallel axes relative to one another as indicated by double-arrow symbols. Either of holders 32, 34 or both of them have respective actuators A₁ and A₂ pivoting the holders relative to one another at the desired angle. The displacement of one or both holders 32, 34 is controlled by a computerized unit 40 until the desired angle between the holders and, thus, the desired splice angle between fiber 36 and 38 is detected. Before fusion, fibers 32, 34 need to be cleaved with a high precision cleaver. Most fusion splicers come with a recommended cleaver. Typically, the fibers to be spliced are placed into a protective sleeve.

The inventive beam shaper 10 can be configured using only passive fibers, only active fiber or a combination of passive and active fibers. A particularly advantageous application of beam shaper 10 can be found in a high power fiber laser system including a master oscillator (MO) and power fiber amplifier configuration (MOPFA), as explained below.

FIG. 8 shows a highly diagrammatic exemplary schematic of MOPFA 42 which is configured with a SM MO 50 coupled to a power fiber amplifier 52. Typically MO 50 and power amplifier 52 have one or more preamplifiers therebetween, but a direct connection between these devices, as illustrated, is not excluded. The MO 50 may be selected from a variety of lasers including a pigtailed diode, fiber laser and any other laser with a SM output fiber 44. The power amplifier (as well as any preamplifier) typically has at least an input SM or MM passive fiber 46 and a MM active fiber 48 doped with any appropriate rare-earth ions or a combination of several rare-earth ions. The fibers 44, 46 and 48 are fused together by respective splices 54. The combination of several fibers offers various structural combinations each utilizing the inventive beam shaper concept as disclosed below.

For example, MM active fiber 48 of power amplifier 52 can be directly spliced to output SM passive fiber 44 of MO 50 at the desired splice angle thus making input passive fiber 46 obsolete in this structural configuration. Alternatively, SM passive fiber 44 can be directly spliced with input passive fiber 46 of amplifier 52 in a coaxial manner. In this configuration, SM or MM passive fiber 46 of power amplifier (PA) 52 is fused with active fiber 48 at the splice angle similarly to the configuration of FIG. 4. Still another structural modification may include a direct angular splice between active fibers 56 and 48 of respective MO 50 and PA 52 resembling thus the configuration of FIG. 1. Obviously the latter configuration does not incorporate passive fibers 44 and 46. Finally, active fiber 56 of MO 50 may be aligned with and directly coupled to input passive 46 of PA 52 which, in turn, is spliced to active fiber 48 of PA 52 in accordance with configurations of FIGS. 1 and 4. The use of active MM fibers can provide not only the desired beam shape transformation at the output of MOPFA 42, but also it can increase the output power of the system up to a kW level. If one or more intermediate pre-amplifiers are incorporated in MOPFA 42, the PA 52 is spliced to an output fiber of upstream intermediary amplifier at a splice angle and thus is coupled to the input SM fiber of MO 50 at the desired splice angle. If needed, any preamplifier may be spliced directly or indirectly to MO 50 at the splice angle as well.

The aspects disclosed herein in accordance with the present invention, are not limited in their application to the details of construction and the arrangement of components set forth in the following description or illustrated in the accompanying drawings. These aspects are capable of assuming other modifications and of being practiced or of being carried out in various ways. Examples of specific implementations are provided herein for illustrative purposes only and are not intended to be limiting. In particular, components and features discussed in connection with any of the above-disclosed modifications are not intended to be excluded from a similar role in any other structural possibilities.

Also, the phraseology and terminology used herein is for the purpose of description and should not be regarded as limiting. References in the singular or plural form are not intended to limit the presently disclosed systems, their components or elements. In addition, in the event of inconsistent usages of terms between this document and documents incorporated herein by reference, the term usage in the incorporated reference is supplementary to that of this document; for irreconcilable inconsistencies, the term usage in this document controls.

Having thus described several aspects of the disclosed structures, one of ordinary skill in the art readily appreciates that various alterations, modifications, and improvements will readily occur to those skilled in the art. For instance, examples disclosed herein are applicable to various laser operations including continuous wave (CW), pulsed and quasi-continuous wave (QCW) regimes. Such alterations, modifications, and improvements are part of this disclosure. Accordingly, the foregoing description and drawings are by way of example only.

1. A beam shaper comprising upstream and downstream fibers fused at a splice angle which is different from a zero angle and selected to provide a transformation of a Gaussian intensity distribution profile at an input of the upstream fiber to an intensity distribution profile different from the Gaussian at an output of the downstream fiber.

2. The beam shaper of claim 1, wherein the intensity distribution profile at the output of the downstream fiber is selected from the group consisting of a standard flattop, inverse Gaussian, and donut-shaped intensity distribution profile and a transient intensity distribution profile between consecutive standard intensity distribution profiles.

3. The beam shaper of claim 2, wherein the splice angle is defined between a continuation of a fiber axis of the input fiber and a fiber axis of the output fiber, each subsequent intensity distribution profile in a group of consecutive standard Gaussian, flattop, inverse Gaussian and donut-shaped intensity profiles corresponding to the splice angle greater than that one associated with a previous intensity distribution profile.

4. The beam shaper of claim 2, wherein the splice angle is selected to obtain any of the standard and intermediary intensity distributions profiles at power losses of light, propagating through a splice between the upstream and downstream fibers, which do not exceed a predetermined reference value.

5. The beam shaper of claim 2, wherein the downstream fiber is a multimode (MM) fiber, the upstream fiber being a single mode (SM) fiber.

6. The beam shaper of claim 1 further comprising at least one additional fiber spliced to an input of the upstream fiber and coaxial therewith, wherein the one additional, upstream and downstream fibers are SM, MM and MM fibers respectively.

7. The beam shaper of claim 1, wherein the upstream and downstream fibers each are selected from passive or active fibers.

8. The beam shaper of claim 1, wherein the downstream fiber is configured with a numerical aperture greater than that of the upstream fiber.

9. A master oscillator power fiber amplifier (MOPFA) system comprising
a master oscillator (MO) outputting at a SM beam with a Gaussian intensity distribution profile via an output SM fiber; and
a power fiber amplifier configured with an active MM fiber, wherein the output SM fiber and active MM fiber are coupled at a splice angle which is different from a zero angle and selected to provide a transformation of the Gaussian intensity distribution profile to an intensity distribution profile different from the Gaussian at an output of the power fiber amplifier.

10. The MOPFA system of claim 9, wherein the output SM fiber of the MO is directly spliced to the active MM fiber at the splice angle.

11. The MOPFA system of claim 9, wherein the one amplifier is further configured with a SM or MM input passive fiber extending collinearly with the output SM fiber and directly spliced to the MM at the splice angle.

12. The MOPFA system of claim 9 further comprising at least one intermediary fiber amplifier which extends collinearly with the output SM fiber of the MO and fused at the splice angle with the power fiber amplifier.

13. A fiber holding assembly of a fusion splicer for coupling upstream and downstream fibers into a beam shaper, comprising:
two fiber holders receiving respective upstream and downstream fibers and mounted to pivot relative to one another about respective parallel axes so as to provide a desired splice angle between the upstream and downstream fibers, and
a control unit operative to controllably increase the splice angle so as to provide a gradual transformation of a Gaussian intensity distribution profile at an input of the upstream fiber to sequential standard flattop, inverse Gaussian and donut-shaped intensity distribution profiles at an output of the downstream fiber.

14. The fiber holding assembly of claim 13, where the control unit is operative to provide angular displacement of the fiber holders at the spice angle associated with transient intensity distribution profiles between consecutive standard intensity distribution profiles.

15. The fiber holding assembly of claim 13, wherein the downstream fiber is a multimode (MM) fiber, the upstream fiber being a single mode (SM) fiber.

16. The fiber holding assembly of claim 13, wherein the upstream and downstream fibers each are a MM fiber.

17. The fiber holding assembly of claim 13, wherein the upstream and downstream fibers each are selected from passive or active fibers.

18. The fiber holding assembly of claim 13, wherein the splice angle varies in a 0 to 15° range.

19. The fiber holding assembly of claim 9, wherein the plurality of fibers includes at least one additional fiber coaxially spliced with the upstream fiber.
